(19) United States
(12) Patent Application Publication
(10) Pub. No.: US 2020/0301441 A1
(43) Pub. Date: Sep. 24, 2020

(54) SERVICE PROVIDING SYSTEM AND VEHICLE

(71) Applicant: TOYOTA JIDOSHA KABUSHIKI KAISHA, Toyota-shi (JP)

(72) Inventors: Kunihiro Murakami, Okazaki-shi (JP); Katsuhiko Sakakibara, Kariya-shi (JP); Makoto Matsushita, Ichinomiya-shi (JP); Junya Sato, Nagoya-shi (JP); Kiyonori Yoshida, Toyota-shi (JP); Tae Sugimura, Miyoshi-shi (JP); Takashi Hayashi, Aichi-gun (JP); Jun Endo, Nagoya-shi (JP)

(73) Assignee: TOYOTA JIDOSHA KABUSHIKI KAISHA, Toyota-shi (JP)

(21) Appl. No.: 16/789,495

(22) Filed: Feb. 13, 2020

(30) Foreign Application Priority Data
Mar. 19, 2019 (JP) 2019-051565

(51) Int. Cl. G05D 1/02; B60D 99/00; G05D 1/00

(52) U.S. Cl. CPC G05D 1/0287; G05D 2201/0212; G05D 1/0088; B60D 7/00

(57) ABSTRACT

A service providing system includes a first vehicle, a second vehicle, and a management device. The first vehicle is a vehicle able to perform autonomous traveling, is a shared vehicle to be usable by a plurality of users, and is configured to provide a predetermined service to a user who uses the first vehicle. The second vehicle is a vehicle able to perform autonomous traveling, is a vehicle to be boarded by a specific user among the users, is connectable to the first vehicle, and as being connected to the first vehicle, allows the specific user to receive the predetermined service. The management device transmits traveling information for autonomous traveling to at least one vehicle such that the first vehicle and the second vehicle join with each other.

### INCORPORATION BY REFERENCE

The disclosure of Japanese Patent Application No. 2019-051565 filed on Mar. 19, 2019 including the specification, drawings and abstract is incorporated herein by reference in its entirety.

### BACKGROUND

### 1. Technical Field

The present disclosure relates to a service providing system that provides a service to a user who boards a vehicle able to perform autonomous traveling, and a vehicle able to perform autonomous traveling.

### 2. Description of Related Art

In recent years, various techniques relating to vehicles able to perform autonomous traveling have been developed. For example, Japanese Unexamined Patent Application Publication No. 2016-218736 (JP 2016-218736 A) discloses an unmanned carrier that receives information from a plurality of information transmission units buried in a road surface and performs autonomous traveling along a traveling route.

### SUMMARY

The disclosure provides a technique capable of improving convenience in a case where a user who boards a vehicle able to perform autonomous traveling receives provision of a service.

A first aspect of the disclosure relates to a service providing system. The service providing system includes a first vehicle, a second vehicle, and a management device. The first vehicle is a vehicle able to perform autonomous traveling, is a shared vehicle usable by a plurality of users, and provides a predetermined service to a user who uses the first vehicle. The second vehicle is a vehicle able to perform autonomous traveling, is a vehicle to be boarded by a specific user among the users, is connectable to the first vehicle, and as being connected to the first vehicle, allows the specific user to receive the predetermined service provided by the first vehicle. The management device is configured to transmit traveling information for autonomous traveling to at least one of the first vehicle and the second vehicle such that the first vehicle and the second vehicle join with each other in a case where user information including information to the effect that the specific user requests provision of the predetermined service is received.

A second aspect of the disclosure relates to a vehicle that is used as the first vehicle in the service providing system according to the first aspect.

A third aspect of the disclosure relates to a vehicle that is used as the second vehicle in the service providing system according to the first aspect.

According to the aspects of the disclosure, it is possible to improve convenience in a case where a user who boards a vehicle able to perform autonomous traveling receives provision of a service.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing the schematic configuration of a service providing system according to a first embodiment;

FIG. 2 is a diagram showing a state in which a service vehicle and a user vehicle are connected to each other;

FIG. 3 is a block diagram showing an example of the functional configuration of the service vehicle according to the first embodiment;

FIG. 4 is a block diagram showing an example of the functional configuration of a management server according to the first embodiment;

FIG. 5 is a flowchart showing a flow of information processing according to the first embodiment that is executed in a traveling information generation unit;

FIG. 6 is a diagram showing an example of the table configuration of user information according to the first embodiment;

FIG. 7 is a diagram showing the schematic configuration of a service providing system according to a second embodiment;

FIG. 8 is a block diagram showing an example of the functional configuration of a management server according to the second embodiment;

FIG. 9 is a diagram showing an example of the table configuration of service vehicle information according to the second embodiment;

FIG. 10 is a flowchart showing a flow of information processing according to the second embodiment that is executed in the traveling information generation unit; and

FIG. 11 is a diagram showing an example of the table configuration of the user information according to the second embodiment.

### DETAILED DESCRIPTION OF EMBODIMENTS

A service providing system according to an embodiment of the disclosure includes a first vehicle, a second vehicle, and a management device. Both of the first vehicle and the second vehicle are vehicles that are able to perform autonomous traveling. The first vehicle is a shared vehicle that is usable by a plurality of users who uses the service providing system according to the embodiment the disclosure. The first vehicle provides a predetermined service to the users who use the service providing system.

The second vehicle is a vehicle that is boarded by a specific user among the users who use the service providing system according to the embodiment of the disclosure. The second vehicle is configured to be connectable to the first vehicle. The second vehicle allows the specific user to receive the predetermined service provided by the first vehicle as being connected to the first vehicle.

The management device is a device that manages traveling of the first vehicle and the second vehicle. The management device receives user information relating to the specific user who boards the second vehicle. In the user information, information to the effect that the specific user requests provision of the predetermined service is included. In a case where the user information is received, the management device transmits traveling information for autonomous traveling to at least one of the first vehicle and the second vehicle such that the first vehicle and the second vehicle join with each other. Here, the traveling information may be information for generating a traveling route or a traveling schedule of the vehicle.

According to the embodiment of the disclosure, in a case where the management device receives the user information relating to the specific user, the first vehicle that provides the predetermined service and the second vehicle that is boarded by the specific user join with each other through the autonomous traveling. In a case where the first vehicle and the second vehicle join with each other, the second vehicle is connectable to the first vehicle. Then, as the second vehicle is connected to the first vehicle, the specific user can receive the predetermined service provided by the first vehicle. Accordingly, even though the second vehicle itself that is boarded by the specific user does not have a function of providing the predetermined service, the specific user can receive provision of the predetermined service in a state of boarding the second vehicle. For this reason, it is possible to improve convenience in a case where a user who boards a vehicle able to perform autonomous traveling receives provision of a service.

Hereinafter, a specific embodiment of the disclosure will be described referring to the drawings. The dimensions, materials, shapes, relative arrangements, and the like of components described in this example are not intended to limit the scope of the disclosure to these alone in particular as long as there are no specific statements.

### First Embodiment

Outline of System

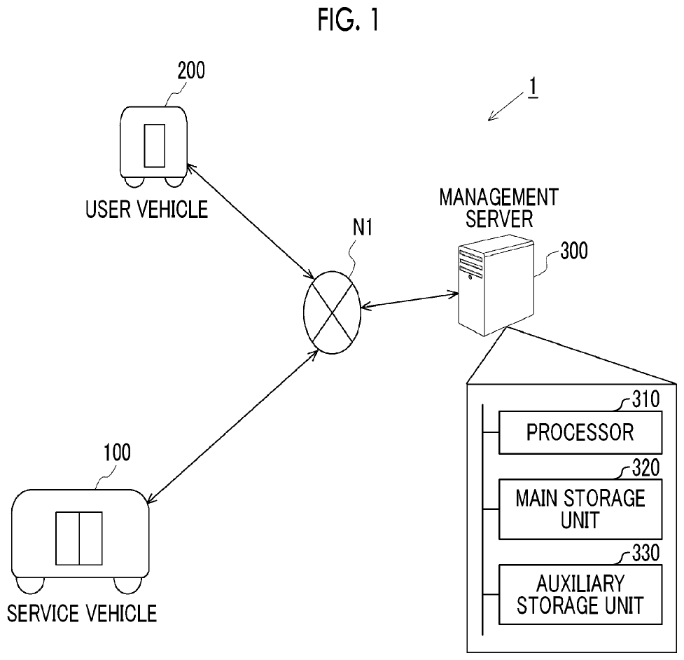

FIG. 1 is a diagram showing the schematic configuration of a service providing system according to the embodiment. A service providing system 1 includes a service vehicle 100, a user vehicle 200, and a management server 300. Both of the service vehicle 100 and the user vehicle 200 are vehicles that are able to perform autonomous traveling.

The service providing system 1 is a system that is used by a plurality of users. The service vehicle 100 provides a predetermined service to each user who uses the service providing system 1. That is, the service vehicle 100 is a shared vehicle that is usable by the users. Here, the predetermined service that is provided to the users by the service vehicle 100 may be, for example, a service for producing food, such as pizza, bread, or noodle, within the vehicle and selling food to the users. Alternatively, the predetermined service that is provided to the users by the service vehicle 100 may be a service for providing a space within the service vehicle 100 to the users as a rest space or a conference space. The service vehicle 100 includes a facility according to a providing service within the vehicle.

On the other hand, the user vehicle 200 is a vehicle that is boarded by a specific user among the users who use the service providing system 1. The user vehicle 200 does not have a function of providing the predetermined service provided by the service vehicle 100. As described above, the service providing system 1 is used by the users. Each user uses the service providing system 1 in a state of boarding the user vehicle associated with the individual. Accordingly, a plurality of user vehicles is present. The user vehicle 200 shown in FIG. 1 is one of the user vehicles.

In the service providing system 1, the service vehicle 100, the user vehicle 200, and the management server 300 are connected to one another through a network N1. As the network N1, for example, a wide area network (WAN) that is a worldwide public communication network, such as the Internet, or a telephone communication network for a mobile phone may be employed.

The management server 300 is a server that manages traveling of the service vehicle 100 and the user vehicle 200. The management server 300 can transmit traveling information for autonomous traveling to each of the service vehicle 100 and the user vehicle 200 through the network N1. The service vehicle 100 and the user vehicle 200 perform autonomous traveling based on the traveling information in a case where the traveling information is received from the management server 300.

The management server 300 includes a general computer. The computer constituting the management server 300 includes a processor 310, such as a CPU or a DSP, a main storage unit 320, such as a read only memory (ROM) or a random access memory (RAM), and auxiliary storage unit 330, such as an EPROM, a hard disk drive (HDD), or a removable medium. Here, the removable medium is, for example, a flash memory, such as a USB memory or an SD card, or a disk recording medium, such as a CD-ROM, a DVD, or a Blu-ray disc.

In the management server 300, an operating system (OS), various programs, various information tables, and the like are stored in the auxiliary storage unit 330. In the management server 300, the processor 310 loads a program stored in the auxiliary storage unit 330 in the main storage unit 320 and executes the program, thereby being able to implement various functions described below. Note that a part or all of the functions in the management server 300 may be implemented by a hardware circuit, such as an ASIC or an FPGA. The management server 300 is not necessarily implemented by a single physical configuration, and may be constituted by a plurality of computers that cooperates with one another.

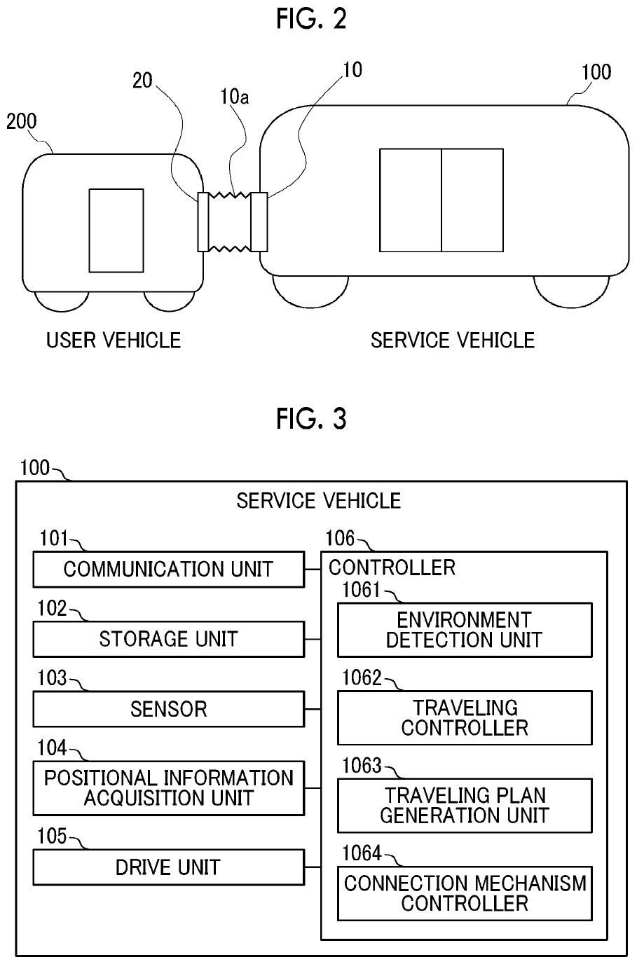

Each of the service vehicle 100 and the user vehicle 200 has a mechanism capable of connecting both vehicles 100, 200 to each other. FIG. 2 is a diagram showing a state in which the service vehicle 100 and the user vehicle 200 are connected to each other. The service vehicle 100 has a connection mechanism 10 that is provided for connection to the user vehicle 200. The user vehicle 200 has a connection mechanism 20 that is provided for connection to the service vehicle 100. The connection mechanism 20 of the user vehicle 200 includes an opening that communicates the inside and the outside of the user vehicle 200, and an automatic door that opens or closes the opening. The connection mechanism 10 of the service vehicle 100 also includes an opening that communicates the inside and the outside of the service vehicle 100, and an automatic door that opens or closes the opening. The connection mechanism 10 of the service vehicle 100 includes an extendable boarding bridge 10a.

In a case where the service vehicle 100 is traveling alone, the boarding bridge 10a is housed inside a body of the connection mechanism 10. Then, in a case where the user vehicle 200 is connected to the service vehicle 100, the boarding bridge 10a extends from the connection mechanism 10 of the service vehicle 100, and an end portion of the boarding bridge 10a is connected to the connection mechanism 20 of the user vehicle 200. Then, the opening of the service vehicle 100 and the opening of the user vehicle 200 are communicated by the boarding bridge 10a . In this way, in a case where the service vehicle 100 and the user vehicle 200 are connected to each other by the connection mechanisms 10, 20, a predetermined article (for example, food) relating to the predetermined service provided by the service vehicle 100 or a user who is boarding the user vehicle 200 is movable between the service vehicle 100 and the user vehicle 200 through the boarding bridge 10a . As a result, the user who is boarding the user vehicle 200 can receive provision of the predetermined service from the service vehicle 100.

That is, for example, in a case where the predetermined service provided by the service vehicle 100 is a service for producing and selling food, the user who is boarding the user vehicle 200 can receive food produced within the service vehicle 100 through the boarding bridge 10a . For example, in a case where the predetermined service provided by the service vehicle 100 is a service for providing a space within the service vehicle 100 as a rest space or a conference space, the user who is boarding the user vehicle 200 can move to the service vehicle 100 through the boarding bridge 10a and can use the space within the service vehicle 100.

The connection mechanism of each of the service vehicle 100 and the user vehicle 200 are not limited to such a mechanism that the service vehicle 100 and the user vehicle 200 are connected to each other through the boarding bridge 10a described above. For example, a housing portion that houses the user vehicle 200 is formed in a body of the service vehicle 100, and both vehicles 100, 200 may include a connection mechanism having such a structure that the user vehicle 200 is housed in the housing portion and the service vehicle 100 and the user vehicle 200 are connected to each other. That is, the connection mechanism of each of the service vehicle 100 and the user vehicle 200 may have such a structure that the predetermined article relating to the predetermined service provided by the service vehicle 100 or the user who is boarding the user vehicle 200 is movable between the service vehicle 100 and the user vehicle 200 in a case where the service vehicle 100 and the user vehicle 200 are physically connected through the connection mechanisms. In a case where the predetermined service provided by the service vehicle 100 is a service for selling the predetermined article to the user, the user does not necessarily move between the service vehicle 100 and the user vehicle 200. For this reason, in this case, the connection mechanism of each of the service vehicle 100 and the user vehicle 200 may have such a structure that the predetermined article is movable between the service vehicle 100 and the user vehicle 200 in a case where the service vehicle 100 and the user vehicle 200 are connected to each other through the connection mechanisms.

Then, in a case where user information including information to the effect that the user who is boarding the user vehicle 200 requests provision of the predetermined service provided by the service vehicle 100 is received, the management server 300 generates traveling information for each of both vehicles 100, 200 such that both vehicles 100, 200 join with each other. The management server 300 transmits the generated traveling information to both vehicles 100, 200 through the network N1. In a case where the service vehicle 100 and the user vehicle 200 receive such traveling information, both vehicles 100, 200 join with each other through autonomous traveling. As a result, the service vehicle 100 and the user vehicle 200 are connected to each other through the connection mechanisms 10, 20.

Functional Configuration

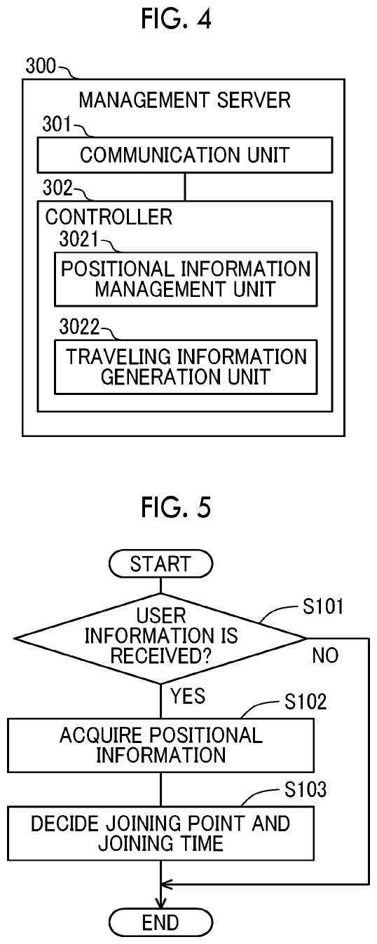

Next, the functional configurations of the service vehicle 100 and the management server 300 constituting the service providing system according to the embodiment will be described referring to FIGS. 3 and 4. The functional configurations of the user vehicle 200 relating to autonomous traveling control and connection mechanism control are the same as those in the service vehicle 100, and thus, description thereof will not be repeated.

Service Vehicle

FIG. 3 is a block diagram showing an example of the functional configuration of the service vehicle according to the embodiment. As described above, the service vehicle 100 is an autonomous traveling vehicle that performs autonomous traveling based on the traveling information transmitted from the management server 300. The service vehicle 100 includes a communication unit 101, a storage unit 102, a sensor 103, a positional information acquisition unit 104, a drive unit 105, and a controller 106. The service vehicle 100 is an electric vehicle that has a motor as a prime motor. Note that the prime motor of the service vehicle 100 is not limited to an electric motor, and may be an internal combustion engine. Alternatively, the service vehicle 100 may be a hybrid vehicle that has both of a motor and an internal combustion engine as a prime motor.

The communication unit 101 has a function of connecting the service vehicle 100 to the network N1. The communication unit 101 can perform communication with other devices including the management server 300 by way of the network N1, for example, using a mobile communication service, such as 3rd Generation (3G) or Long Term Evolution (LTE). The controller 106 executes processing for transmitting positional information relating to a current position of the host vehicle acquired by the positional information acquisition unit 104 described below to the management server 300 through the communication unit 101. The controller 106 executes processing for receiving the traveling information, which is transmitted from the management server 300 to the service vehicle 100, through the communication unit 101. The communication unit 101 may further have a communication device that performs vehicle-to-vehicle communication with other vehicles.

The storage unit 102 is a device that stores information, and is a constituted of a storage medium, such as a magnetic disk or a flash memory. In the storage unit 102, for example, map information is stored. In the storage unit 102, a traveling plan of the service vehicle 100 to be generated by a traveling plan generation unit 1063 described below is stored.

The sensor 103 is a device that senses circumstances around the service vehicle 100. Specifically, the sensor 103 includes a stereo camera, a laser scanner, LIDAR, a radar, or the like. Information relating to the circumstances around the service vehicle 100 acquired by the sensor 103 is transmitted to the controller 106. The positional information acquisition unit 104 is a device that acquires the current position of the service vehicle 100, and specifically, includes a GPS receiver or the like. The positional information relating to the current position of the service vehicle 100 acquired by the positional information acquisition unit 104 is transmitted to the controller 106.

The controller 106 has a function of executing arithmetic processing for controlling the service vehicle 100. The controller 106 is constituted of, for example, a microcomputer. The controller 106 has, as functional modules, an environment detection unit 1061, a traveling controller 1062, a traveling plan generation unit 1063, and a connection mechanism controller 1064. Each functional module may be implemented by a processor, such as a CPU, executing a program stored in a storage unit, such as a ROM, in the controller 106. A part or all of the functions may be implemented by a hardware circuit, such as an ASIC or an FPGA.

The environment detection unit 1061 detects an environment around the service vehicle 100 based on information acquired by the sensor 103. For example, the environment detection unit 1061 detects an object (including a person or an animal), such as other vehicles, around the host vehicle. The environment detection unit 1061 detects various targets needed for autonomous traveling of the service vehicle 100, such as the number of lanes on a road, the structure of roads, and road signs. The environment detection unit 1061 may track a detected object. In this case, for example, a difference between coordinates of an object detected before one step and current coordinates of the object may be used to obtain a relative speed of the object.

The traveling controller 1062 controls traveling of the service vehicle 100 based on the traveling plan stored in the storage unit 102, the positional information of the service vehicle 100 acquired by the positional information acquisition unit 104, and data of the surrounding environment detected by the environment detection unit 1061. For example, the traveling controller 1062 makes the service vehicle 100 travel on a traveling route included in the traveling plan along a traveling schedule included in the traveling plan. In a case where an object with which the service vehicle 100 is likely to collide is detected by the environment detection unit 1061, the traveling controller 1062 executes collision avoidance control for making the service vehicle 100 travel so as to avoid collision with the object. In regard to a method of making the service vehicle 100 perform autonomous traveling as described above, a known method can be employed.

The traveling plan generation unit 1063 generates the traveling plan of the host vehicle including the traveling route or the traveling schedule based on the traveling information received from the management server 300. As described below, in the traveling information transmitted from the management server 300, a joining point and a joining time of the service vehicle 100 and the user vehicle 200 are included. Then, the traveling plan generation unit 1063 generates such a traveling plan that the host vehicle arrives at the joining point at the joining time.

The drive unit 105 includes a motor that is a prime motor, and a mechanism (for example, an inverter, a brake, and a steering mechanism) that makes the service vehicle 100 travel. The drive unit 105 makes the host vehicle travel based on a command that the traveling controller 1062 generates in order to control traveling of the service vehicle 100. With this, autonomous traveling of the service vehicle 100 is implemented.

The connection mechanism controller 1064 controls the connection mechanism 10 of the service vehicle 100. The connection mechanism controller 1064 extends the boarding bridge 10a of the connection mechanism 10 toward the user vehicle 200 and connects the end portion of the boarding bridge 10a to the connection mechanism 20 of the user vehicle 200 in a case where both vehicles 100, 200 are connected to each other after the service vehicle 100 and the user vehicle 200 join with each other. After the service vehicle 100 and the user vehicle 200 join with each other, traveling of both vehicles 100, 200 may be controlled through vehicle-to-vehicle communication such that the boarding bridge 10a extended from the connection mechanism 10 of the service vehicle 100 is connectable to the connection mechanism 20 of the user vehicle 200.

The service vehicle 100 is not necessarily a vehicle that travels in an unmanned manner. For example, a person who takes a service staff in charge of providing the predetermined service to the users, a security staff in charge of security of the service vehicle 100, or the like may board in the service vehicle 100. The service vehicle 100 and the user vehicle 200 may not necessarily be vehicles that perform autonomous traveling continuously. For example, the service vehicle 100 and the user vehicle 200 may be vehicles that are switchable between an autonomous driving mode and a manual driving mode.

Management Server

FIG. 4 is a block diagram showing an example of the functional configuration of the management server according to the embodiment. The management server 300 includes a communication unit 301 and a controller 302. The communication unit 301 has a function of connecting the management server 300 to the network N1. The communication unit 301 includes, for example, a local area network (LAN) interface port or a wireless communication circuit for wireless communication. The controller 302 has a function of executing arithmetic processing for controlling the management server 300. The controller 302 can be implemented by the processor 310.

The controller 302 executes processing for receiving the positional information relating to the current position of each vehicle transmitted from each of the service vehicle 100 and the user vehicle 200 through the communication unit 301. The user information including information to the effect that the user who is boarding the user vehicle 200 requests provision of the predetermined service provided by the service vehicle 100 is transmitted from the user vehicle 200. The controller 302 executes processing for receiving the user information, which is transmitted from the user vehicle 200, through the communication unit 301. The user information may be transmitted from an in-vehicle device mounted in the user vehicle 200 or may be transmitted a terminal carried with the user who is boarding the user vehicle 200. The controller 302 executes processing for transmitting the traveling information generated by a traveling information generation unit 3022 described below to the service vehicle 100 and the user vehicle 200 through the communication unit 301.

The controller 302 has, as functional modules, a positional information management unit 3021 and a traveling information generation unit 3022. The positional information management unit 3021 manages the positional information relating to the current position of each of the service vehicle 100 and the user vehicle 200 received through the communication unit 301. The traveling information generation unit 3022 executes processing for generating the traveling information transmitted to the vehicles 100, 200 based on the positional information relating to the current position of each of the service vehicle 100 and the user vehicle 200 managed in the positional information management unit 3021 and the user information received from the user vehicle 200.

Information Processing

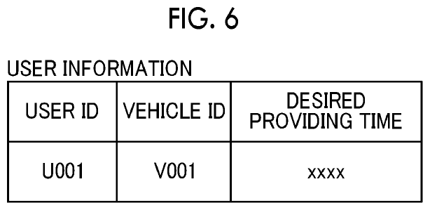

Here, information processing for generating the traveling information transmitted to the service vehicle 100 and the user vehicle 200 that is executed in the traveling information generation unit 3022 will be described referring to FIGS. 5 and 6. FIG. 5 is a flowchart showing a flow of the information processing according to the embodiment that is executed in the traveling information generation unit 3022. FIG. 6 is a diagram showing an example of the table configuration of the user information according to the embodiment that is received from the user vehicle 200 by the management server 300.

In the flow shown in FIG. 5, first, in S101, determination is made whether or not the user information is received from the user vehicle 200. As shown in FIG. 6, the user information received from the user vehicle 200 has a user ID field, a vehicle ID field, and a desired providing time field. In the user ID field, a user ID that is information for specifying a user who requests to receive provision of the predetermined service of the service vehicle 100 is input. In the vehicle ID field, a vehicle ID that is information for specifying the user vehicle 200 boarded by the user who requests to receive provision of the predetermined service is input. In the desired providing time field, a desired providing time that is designated as a time at which the user desires to receive provision of the predetermined service is input. In the user information, information relating to a place where the user desires to receive provision of the predetermined service may be included in addition to the desired providing time.

In a case where negative determination is made in S101, the execution of the information processing according to the flow is stopped once. On the other hand, in a case where affirmative determination is made in S102, processing of S102 and S103 is executed in order to generate the traveling information. In S102, the positional information relating to the current position of each of the service vehicle 100 and the user vehicle 200 managed in the positional information management unit 3021 is acquired.

Next, in S103, the joining point and the joining time of both vehicles 100, 200 are decided based on the desired providing time included in the user information and the current position of each of the service vehicle 100 and the user vehicle 200. Here, a time before the desired providing time included in the user information is decided as the joining time of both vehicles 100, 200 in order to provide the predetermined service to the user who boards the user vehicle 200 at the desired providing time. A place where both of the service vehicle 100 and the user vehicle 200 are arrivable before the decided joining time is decided as the joining point. Then, the joining point and the joining time of the service vehicle 100 and the user vehicle 200 decided in S103 are set as the traveling information.

As the traveling information generated through the information processing described above is transmitted to the service vehicle 100 and the user vehicle 200, the traveling plan in each of both vehicles 100, 200 is generated and autonomous traveling of both vehicles 100, 200 is controlled such that both vehicles 100, 200 join with each other until the desired providing time of the user. As a result, the service vehicle 100 and the user vehicle 200 join with each other, whereby both vehicles 100, 200 can be connected to each other through the connection mechanisms 10, 20. In a case where information relating to the place where the user desires to receive provision of the predetermined service is included in the user information, the place may be decided as the joining point of both vehicles 100, 200.

The traveling information for making the service vehicle 100 and the user vehicle 200 join with each other is not necessarily transmitted to both vehicles 100, 200. That is, the traveling information is transmitted to either of the service vehicle 100 or the user vehicle 200 to make both vehicles 100, 200 join with each other.

As described above, with the service providing system according to the embodiment, even though the user vehicle 200 itself does not have a function of providing the predetermined service, as the user vehicle 200 is connected to the service vehicle 100 having the function of providing the predetermined service, the user can receive the predetermined service in a state of boarding the user vehicle 200. Accordingly, it is possible to improve convenience in a case where the user who boards the user vehicle 200 able to perform autonomous traveling receives provision of the predetermined service.

### Second Embodiment

Outline of System

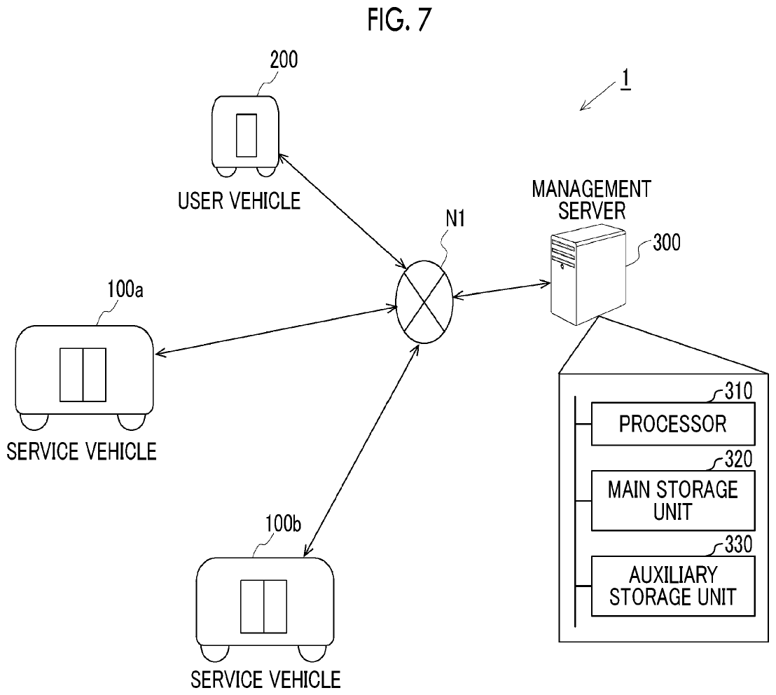

FIG. 7 is a diagram showing the schematic configuration of a service providing system according to the embodiment. In the embodiment, the service providing system 1 includes a plurality of service vehicles 100a, 100b. The service vehicles 100a, 100b provide different services to the users who use the service providing system 1. The service vehicles 100a, 100b are connected to the network N1. Similarly to the service vehicle 100 according to the first embodiment, each of the service vehicles 100a, 100b has a connection mechanism that is provided for connection to the user vehicle 200. The functional configuration of each of the service vehicles 100a, 100b is the same as the service vehicle 100 according to the first embodiment. In the following description, the service vehicles 100a, 100b are simply referred to as “service vehicles 100”.

Functional Configuration

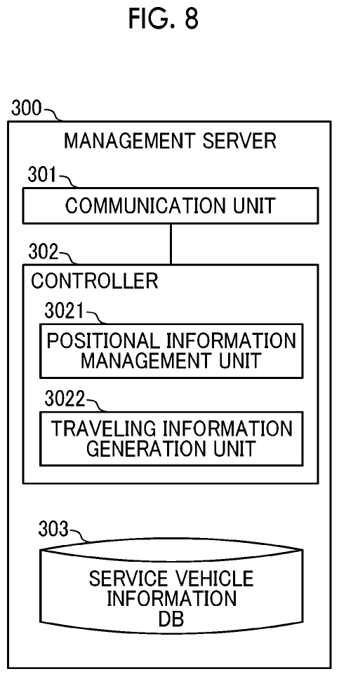

FIG. 8 is a block diagram showing an example of the functional configuration of the management server according to the embodiment. Even in the embodiment, as in the first embodiment, the management server 300 includes the communication unit 301 and the controller 302. Then, the controller 302 executes processing for receiving the positional information relating to the current position of each vehicle transmitted from each service vehicle 100 through the communication unit 301. The positional information management unit 3021 in the controller 302 manages the positional information relating to the current position of each service vehicle 100 received through the communication unit 301.

In the embodiment, the management server 300 includes a service vehicle information database (service vehicle information DB) 303. In the service vehicle information DB 303, a service that is provided to the user by each of the service vehicles 100 under the management of the management server 300 is stored in association with each vehicle 100. The service vehicle information DB 303 is constructed in the auxiliary storage unit 330 of the management server 300 as a program of a database management system is executed by the processor 310 of the management server 300.

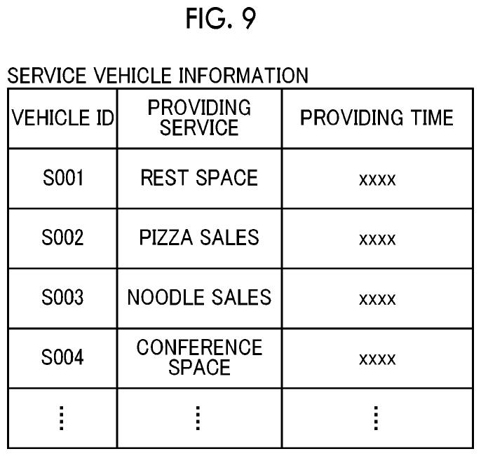

FIG. 9 is a diagram showing an example of the table configuration of the service vehicle information according to the embodiment that is stored in the service vehicle information DB 303. As shown in FIG. 9, a service vehicle information table has a vehicle ID field, a providing service field, and a providing time field. In the vehicle ID field, a vehicle ID that is identification information for specifying the service vehicle 100 is input. In the providing service field, a providing service that is a service to be provided to the user by the service vehicle 100 is input. In the providing time field, a time period during which the service vehicle 100 can provide the providing service to the user is input.

Information Processing

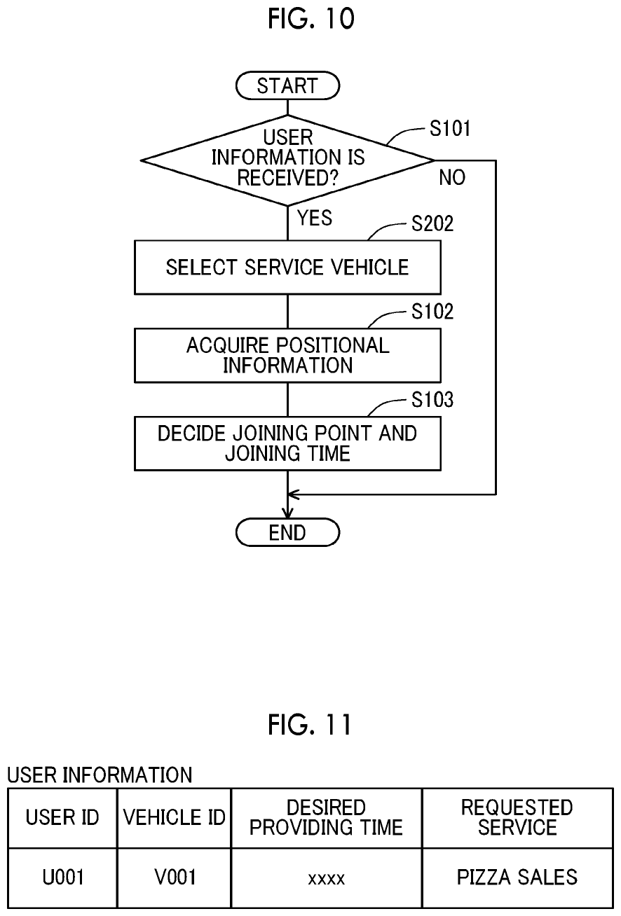

Even in the embodiment, the information processing for generating the traveling information transmitted to the service vehicle 100 and the user vehicle 200 is executed in the traveling information generation unit 3022. Here, in the information processing that is executed by the traveling information generation unit 3022 in the embodiment, a difference from the information processing that is executed in the above-described first embodiment will be described referring to FIGS. 10 and 11. FIG. 10 is a flowchart showing a flow of the information processing according to the embodiment that is executed in the traveling information generation unit 3022. Processing that is executed in each step in the flow excluding S202 is the same as the processing that is executed in the step attached with the same reference numeral in the flow shown in FIG. 5. FIG. 11 is a diagram showing an example of the table configuration of the user information according to the embodiment that is received from the user vehicle 200 by the management server 300.

Even in the flow shown in FIG. 10, similarly to the flow shown in FIG. 5, first, in S101, determination is made whether or not the user information is received from the user vehicle 200. Here, in the embodiment, information relating to a requested service that the user desires to be provided is included in the user information transmitted from the user vehicle 200. In more detail, in the embodiment, as shown in FIG. 11, the user information transmitted from the user vehicle 200 has a requested service field, in addition to the user ID field, the vehicle ID field, and the desired providing time field. Then, the requested service is input in the requested service field.

Then, in a case where affirmative determination is made in S101, next, processing of S202 is executed. In S202, the service vehicle 100 that should provide a service to the user is selected from a plurality of service vehicles 100 (that is, vehicles the service vehicle information of which is stored in the service vehicle information DB 303) under the management of the management server 300. Here, the service vehicle 100 that should provide the service to the user is selected based on the user information received from the user vehicle 200 and the service vehicle information stored in the service vehicle information DB 303. In more detail, in the service vehicle information, the service vehicle 100 that has the requested service included in the user information as the providing service and includes the desired providing time included in the user information within the providing time is selected as the service vehicle 100 that should provide a service to the user.

Thereafter, the processing of S102 and S103 is executed for the service vehicle 100 selected in S202. With this, the joining point and the joining time of the service vehicle 100 and the user vehicle 200 are decided. Then, the decided joining point and joining time of the service vehicle 100 and the user vehicle 200 are set as the traveling information. The traveling information generated through such information processing is transmitted to the service vehicle 100 selected in S202 and the user vehicle 200.

With this, the traveling plan in each of both vehicles 100, 200 is generated and autonomous traveling of both vehicles 100, 200 is controlled such that the service vehicle 100, which provides the requested service of the user, and the user vehicle 200 join with each other until the desired providing time of the user. As a result, as the service vehicle 100, which provides the requested service of the user, and the user vehicle 200 join with each other, both vehicles 100, 200 can be connected to each other through the connection mechanisms 10, 20. Even in the embodiment, the traveling information may be transmitted to either of the service vehicle 100 or the user vehicle 200 to make both vehicles 100, 200 join with each other.

As described above, with the service providing system according to the embodiment, as the user vehicle 200 is connected to the service vehicle 100 having a function of providing the requested service of the user, the user can receive the requested service of the user in a state of boarding the user vehicle 200.

### Other Embodiments

The above-described embodiments are just examples, and the disclosure may be appropriately modified and carried out without departing from the spirit and scope of the disclosure. The processing or units described in the present disclosure can be freely combined and implemented as long as no technical contradiction arises.

Processing described to be executed by one device may be shared and executed by a plurality of devices. Alternatively, processing described to be executed by different devices may be executed by one device. In a computer system, a hardware configuration (server configuration) that implements each function may be flexibly changed.

The disclosure may also be implemented by supplying a computer program mounted with the functions described in the above-described embodiments to a computer and causing one or more processors in the computer to read and execute the program. Such a computer program may be provided to the computer by a non-transitory computer-readable storage medium connectable to a system bus of the computer or may be provided to the computer through a network. The non-transitory computer-readable storage medium includes, for example, any type of disk, such as a magnetic disk (a Floppy (Registered Trademark) disk, a hard disk drive (HDD), or the like), or an optical disk (a CD-ROM, a DVD, a Blu-ray disc, or the like), a read only memory (ROM), a random access memory (RAM), an EPROM, an EEPROM, a magnetic card, a flash memory, an optical card, or any type of medium suitable for storing electronic instructions.

What is claimed is:

1. A service providing system comprising:
a first vehicle that is a vehicle able to perform autonomous traveling, is a shared vehicle usable by a plurality of users, and provides a predetermined service to a user who uses the first vehicle;
a second vehicle that is a vehicle able to perform autonomous traveling, is a vehicle to be boarded by a specific user among the users, is connectable to the first vehicle, and as being connected to the first vehicle, allows the specific user to receive the predetermined service provided by the first vehicle; and
a management device configured to transmit traveling information for autonomous traveling to at least one of the first vehicle and the second vehicle such that the first vehicle and the second vehicle join with each other in a case where user information including information to the effect that the specific user requests provision of the predetermined service is received.

2. The service providing system according to claim 1, wherein:
each of the first vehicle and the second vehicle has a connection mechanism that connects both vehicles to each other;
the connection mechanism is configured such that at least one of a predetermined article relating to the predetermined service and the specific user is movable between the first vehicle and the second vehicle in a case where the first vehicle and the second vehicle are connected to each other through the connection mechanism.

3. The service providing system according to claim 1, wherein:
the user information includes at least timing information that is information relating to a timing, at which the specific user desires provision of the predetermined service; and
the management device generates the traveling information based on the timing information included in the user information.

4. The service providing system according to claim 1, wherein:
a plurality of the first vehicles is provided;
the first vehicles are vehicles that provide different services to users who use the first vehicles; and
the management device selects the first vehicle to be joined with the second vehicle from among the first vehicles based on information relating to a service that the specific user included in the user information requests to be provided.

5. A vehicle that is used as the first vehicle in the service providing system according to claim 1.

6. A vehicle that is used as the second vehicle in the service providing system according to claim 1.
